(19) United States
(12) Patent Application Publication
(10) Pub. No.: US 2016/0370670 A1
(43) Pub. Date: Dec. 22, 2016

(54) LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventor: Feng ZHAO, Shenzhen, Guangdong (CN)

(73) Assignee: Shenzhen China Star Optoelectronics Technology Co. Ltd., Shenzhen, Guangdong (CN)

(21) Appl. No.: 14/433,673

(22) PCT Filed: Jan. 9, 2015
(86) PCT No.: PCT/CN2015/070441

§ 371 Date: Apr. 5, 2015

(30) Foreign Application Priority Data
Dec. 31, 2014 (CN) 201410856448.3

(51) Int. Cl. G02F 1/1343; G02F 1/1335

(52) U.S. Cl. CPC G02F 1/134363; G02F 1/133528; G02F 2001/133562; G02F 2001/133567; G02F 2201/123; G02F 2201/124; G02F 2001/134372

(57) ABSTRACT

A liquid crystal display device includes a first polarizing film, a first substrate, a liquid crystal layer, a second substrate and a second polarizing film. The first polarizing film has a first transmission axis. The first substrate has a first orientation parallel to the first transmission axis. The second substrate has a second orientation parallel to the first transmission axis. The second polarizing film has a second transmission axis perpendicular to the first transmission axis. An incident light from a backlight unit would sequentially pass the first polarizing film, the first substrate, the liquid crystal layer, the second substrate and the second polarizing film. The first substrate and the second substrate have multiple double-domain pixel electrodes. Therefore, the liquid crystal display device can achieve desired blackness in the case of without being applied with voltage, wide viewing angle, low color shift and vivid image quality.

### TECHNICAL FIELD

The invention relates to the field of display technology, and particularly to a liquid crystal display device.

### DESCRIPTION OF RELATED ART

In a traditional in-plane switching (IPS) mode liquid crystal display device or a fringe field switching (FFS) mode liquid crystal display devices, there is a problem of contrast reduction caused by luminance increase at a dark state resulting from the incident light from a backlight unit cannot be completely controlled when displaying the dark state. When the contrast is reduced, black and white images displayed on the liquid crystal display device are not distinct enough from each other, image quality is degraded and therefore it is difficult to display a vivid image.

### SUMMARY

Accordingly, the invention provides a liquid crystal display device, so as to the above technical problem that black and white images of liquid crystal display device are not distinct enough from each other and image quality is degraded.

In order to solve the above technical problem, a technical solution provided by the invention is to provide a liquid crystal display device. The liquid crystal display device includes: a first polarizing film, a first substrate, a liquid crystal layer, a second substrate and a second polarizing film. The first polarizing film has a first transmission axis. The first substrate has a first orientation parallel to the first transmission axis. The second substrate has a second orientation parallel to the first transmission axis. The second polarizing film has a second transmission axis perpendicular to the first transmission axis. An incident light from a backlight unit would sequentially pass the first polarizing film, the first substrate, the liquid crystal layer, the second substrate and the second polarizing film. The first substrate and the second substrate have a plurality of double-domain pixel electrodes. Each of the plurality of double-domain pixel electrodes includes a first comb-shaped electrode and a second comb-shaped electrode, the first comb-shaped electrode being interdigitated with the second comb-shaped electrode. The first comb-shaped electrode and the second comb-shaped electrode are configured for forming a horizontal electric field. The first comb-shaped electrode includes a plurality of spacedly arranged first bending portions and a first connecting portion, the first connecting portion being connected with the plurality of spacedly arranged first bending portions to form a comb-shaped structure. The second comb-shaped electrode includes a plurality of spacedly arranged second bending portions and a second connecting portion, the second connecting portion being connected with the plurality of spacedly arranged second bending portions to form a comb-shaped structure. The plurality of first bending portions and the plurality of second bending portions are spacedly arranged from each other. Each of the plurality of first bending portions and the second connecting portion have a first gap formed therebetween, each of the plurality of second bending portions and the first connecting portion have a second gap formed therebetween. The liquid crystal layer contains dichroic dyes and liquid crystal molecules, the dichroic dyes being parallel to the liquid crystal molecules.

In order to solve the above technical problem, another technical solution provided by the invention is to provide a liquid crystal display device. The liquid crystal display device includes a first polarizing film, a first substrate, a liquid crystal layer, a second substrate and a second polarizing film. The first polarizing film has a first transmission axis. The first substrate has a first orientation parallel to the first transmission axis. The second substrate has a second orientation parallel to the first transmission axis. The second polarizing film has a second transmission axis perpendicular to the first transmission axis. An incident light from a backlight unit would sequentially pass the first polarizing film, the first substrate, the liquid crystal layer, the second substrate and the second polarizing film. The first substrate and the second substrate have a plurality of double-domain pixel electrodes. Each of the plurality of double-domain pixel electrodes includes a first comb-shaped electrode and a second comb-shaped electrode, the first comb-shaped electrode being interdigitated with the second comb-shaped electrode. The first comb-shaped electrode and the second comb-shaped electrode are configured for forming a horizontal electric field. The liquid crystal layer contains dichroic dyes and liquid crystal molecules, the dichroic dyes being parallel to the liquid crystal molecules.

In order to solve the above technical problem, still another technical solution provided by the invention is to provide a liquid crystal display device. The liquid crystal display device includes a first polarizing film, a first substrate, a liquid crystal layer, a second substrate and a second polarizing film. The first polarizing film has a first transmission axis. The first substrate has a first orientation parallel to the first transmission axis. The second substrate has a second orientation parallel to the first transmission axis. The second polarizing film has a second transmission axis perpendicular to the first transmission axis. An incident light from a backlight unit would sequentially pass the first polarizing film, the first substrate, the liquid crystal layer, the second substrate and the second polarizing film. The first substrate and the second substrate have a plurality of double-domain pixel electrodes.

In an embodiment, each of the double-domain pixel electrodes includes a first comb-shaped electrode and a second comb-shaped electrode, the first comb-shaped electrode being interdigitated with the second comb-shaped electrode.

In an embodiment, the first comb-shaped electrode includes a plurality of spacedly arranged first bending portions and a first connecting portion, the first connecting portion being connected with the plurality of spacedly arranged first bending portions to form a comb-shaped structure.

In an embodiment, the second comb-shaped electrode includes a plurality of spacedly arranged second bending portions and a second connecting portion, the second connecting portion being connected with the plurality of spacedly arranged second bending portions to form a comb-shaped structure. The plurality of first bending portions and the plurality of second bending portions are spacedly arranged from each other.

In an embodiment, each of the plurality of first bending portions and the second connecting portion have a first gap formed therebetween, each of the plurality of second bending portions and the first connecting portion have a second gap formed therebetween.

In an embodiment, each of the first bending portions is a “>” shape.

In an alternative embodiment, each of the first bending portions is a “<” shape.

In an embodiment, the first comb-shaped electrode and the second comb-shaped electrode are configured (i.e., structured and arranged) for forming a horizontal electric field.

In an embodiment, the liquid crystal layer contains dichroic dyes and liquid crystal molecules, the dichroic dyes being parallel to the liquid crystal molecules.

In an embodiment, major axes or minor axes of the dichroic dyes are configured for absorbing a part of linear polarized light from the first polarizing film.

In an embodiment, the liquid crystal display device uses a fringe field switching mode or an in-plane switching mode.

The efficacy can be achieved by the invention is that: different from the prior art, the invention provides a liquid crystal display device in which a first substrate and a second substrate have a plurality of double-domain pixel electrodes, so that the liquid crystal display device can achieve desired blackness in the case of without being applied with voltage, wide viewing angle, low color shift and vivid image quality.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a perspective view of a liquid crystal display device of the invention;

FIG. 2 is a schematic cross-sectional view of a liquid crystal display device of the invention;

FIG. 3 is a schematic view of a plurality of double-domain pixel electrodes of a liquid crystal display device of the invention; and

FIG. 4 is a schematic view of one double-domain pixel electrode of the liquid crystal display device in FIG. 3.

### DETAILED DESCRIPTION OF EMBODIMENTS

In the specification and claims, some terms are used to address specific components. The skilled person in the art should be understood that, manufacturers may use different terms to address/name the same components. The specification and claims do not use the name difference as a manner of component distinguishing but use functional difference of components as a base of distinguishing. The invention will be described below in detail in conjunction with embodiments and accompanying drawings.

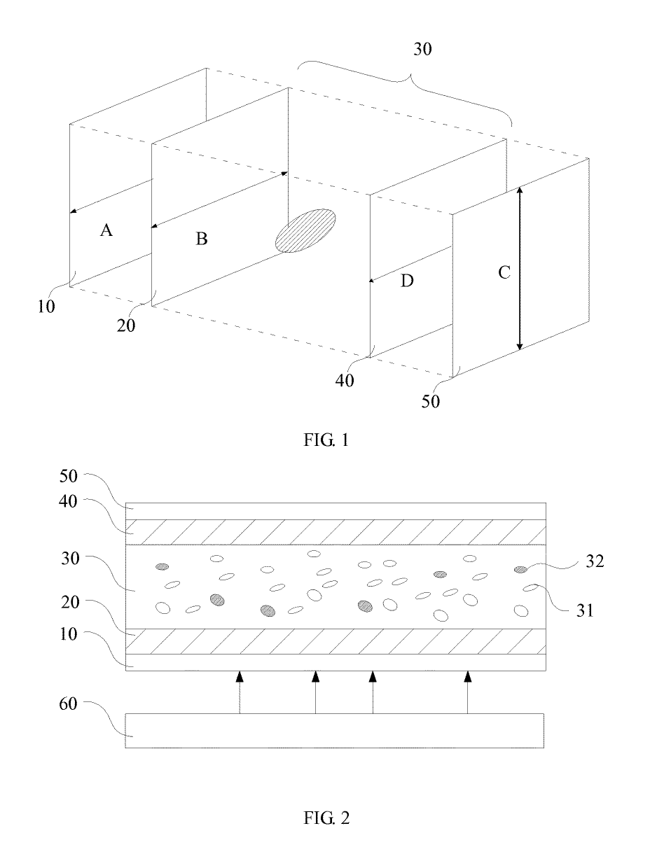

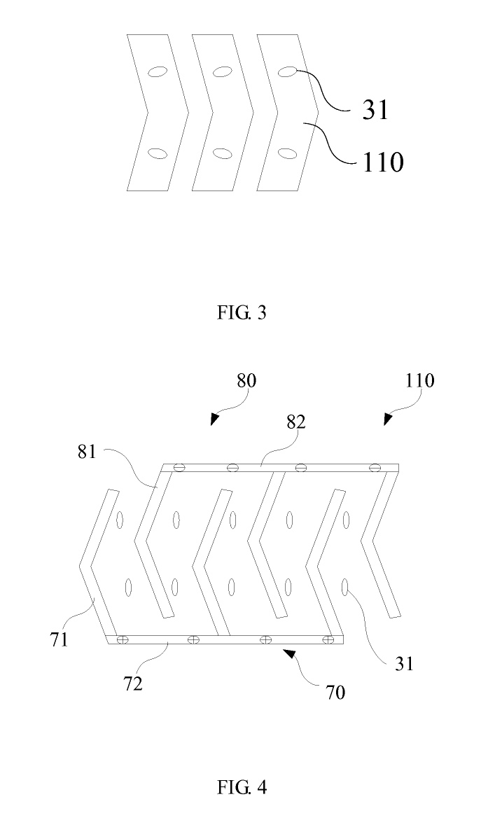

Referring to FIG. 1 through FIG. 4, FIG. 1 is a perspective view of a liquid crystal display device of the invention, FIG. 2 is a schematic cross-sectional view of the liquid crystal display device of the invention, FIG. 3 is a schematic view of a plurality of double-domain pixel electrodes of the liquid crystal display device of the invention, and FIG. 4 is a schematic view of one double-domain pixel electrode of the liquid crystal display device in FIG. 3. The liquid crystal display device of the invention includes a first polarizing film 10, a first substrate 20, a liquid crystal layer 30, a second substrate 40, a second polarizing film 50 and a backlight unit 60.

The first polarizing film 10 has a first transmission axis A, the first substrate 20 has a first orientation B parallel to the first transmission axis A, the second polarizing film 50 has a second transmission axis C perpendicular to the first transmission axis A, and the second substrate 40 has a second orientation D parallel to the first transmission axis A. An incident light from the backlight unit 60 would sequentially pass the first polarizing film 10, the first substrate 20, the liquid crystal layer 30, the second substrate 40 and the second polarizing film 50. As shown in FIG. 3, the first substrate 20 and the second substrate 40 have a plurality of spacedly arranged double-domain pixel electrodes 110 disposed thereon.

As shown in FIG. 4, each of the double-domain pixel electrodes 110 includes a first comb-shaped electrode 70 and a second comb-shaped electrode 80. The first comb-shaped electrode 70 is interdigitated with the second comb-shaped electrode 80. The first comb-shaped electrode 70 includes a plurality of spacedly arranged first bending portions 71 and a first connecting portion 72. The first connecting portion 72 is connected with the plurality of spacedly arranged first bending portions 71 to form a comb-shaped structure. The second comb-shaped electrode 80 includes a plurality of spacedly arranged second bending portions 81 and a second connecting portion 82. The second connecting portion 82 is connected with the plurality of spacedly arranged second bending portions 81 to form a comb-shaped structure. Each of the first bending portions 71 and each of the second bending portions 81 are spacedly arranged from each other. Each of the first bending portions 71 and the second connecting portion 82 have a first gap formed therebetween. Each of the second bending portions 81 and the first connecting portion 72 have a second gap formed therebetween. The number of the first bending portions 71 or the second bending portions 81 may be two, or three, or more than three. Moreover, as seen from FIG. 4, the first bending portions 71 and the second bending portions 81 are alternately arranged.

The first bending portions 71 of the invention each may be a “>” shape or a “<” shape, and the second bending portions 81 each may have a shape same as that of each first bending portion 71.

The liquid crystal layer 30 includes liquid crystal molecules 31 and dichroic dyes 32. The dichroic dyes 32 are parallel to the liquid crystal molecules 31, when applying a positive voltage onto the first comb-shaped electrode 70 and a negative voltage onto the second comb-shaped electrode 80 to form a horizontal electric field between the second bending portions 81 and the first bending portions 71, the liquid crystal molecules 31 are horizontally rotated along two directions, major axes or minor axes of the dichroic dyes 32 may absorb a part of linear polarized light from the first polarizing film 10.

In addition, the liquid crystal display device of the invention adopts a fringe field switching (FFS) mode or in-plane switching (IPS) mode.

In summary, for the liquid crystal display device provided by the invention, the first substrate and the second substrate of the liquid crystal display device have a plurality of double-domain pixel electrodes, so that the liquid crystal display device can achieve desired blackness in the case of without being applied with voltage, wide viewing angle, low color shift and vivid image quality.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display device comprising:
a first polarizing film, having a first transmission axis;
a first substrate, having a first orientation parallel to the first transmission axis;
a liquid crystal layer;
a second substrate, having a second orientation parallel to the first transmission axis;
a second polarizing film, having a second transmission axis perpendicular to the first transmission axis; wherein
an incident light from a backlight unit would sequentially pass the first polarizing film, the first substrate, the liquid crystal layer, the second substrate and the second polarizing film; the first substrate and the second substrate have a plurality of double-domain pixel electrodes;
each of the plurality of double-domain pixel electrodes comprises a first comb-shaped electrode and a second comb-shaped electrode, the first comb-shaped electrode being interdigitated with the second comb-shaped electrode;
the first comb-shaped electrode and the second comb-shaped electrode are configured for forming a horizontal electric field;
the first comb-shaped electrode comprises a plurality of spacedly arranged first bending portions and a first connecting portion, the first connecting portion being connected with the plurality of spacedly arranged first bending portions to form a comb-shaped structure;
the second comb-shaped electrode comprises a plurality of spacedly arranged second bending portions and a second connecting portion, the second connecting portion being connected with the plurality of spacedly arranged second bending portions to form a comb-shaped structure, the plurality of first bending portions and the plurality of second bending portions are spacedly arranged from each other;
each of the plurality of first bending portions and the second connecting portion have a first gap formed therebetween, each of the plurality of second bending portions and the first connecting portion have a second gap formed therebetween;
the liquid crystal layer contains dichroic dyes and liquid crystal molecules, the dichroic dyes being parallel to the liquid crystal molecules.

2. A liquid crystal display device comprising:
a first polarizing film, having a first transmission axis;
a first substrate, having a first orientation parallel to the first transmission axis;
a liquid crystal layer;
a second substrate, having a second orientation parallel to the first transmission axis;
a second polarizing film, having a second transmission axis perpendicular to the first transmission axis; wherein
an incident light from a backlight unit would sequentially pass the first polarizing film, the first substrate, the liquid crystal layer, the second substrate and the second polarizing film; the first substrate and the second substrate have a plurality of double-domain pixel electrodes;
each of the plurality of double-domain pixel electrodes comprises a first comb-shaped electrode and a second comb-shaped electrode, the first comb-shaped electrode being interdigitated with the second comb-shaped electrode;
the first comb-shaped electrode and the second comb-shaped electrode are configured for forming a horizontal electric field;
the liquid crystal layer contains dichroic dyes and liquid crystal molecules, the dichroic dyes being parallel to the liquid crystal molecules.

3. A liquid crystal display device comprising:
a first polarizing film, having a first transmission axis;
a first substrate, having a first orientation parallel to the first transmission axis;
a liquid crystal layer;
a second substrate, having a second orientation parallel to the first transmission axis;
a second polarizing film, having a second transmission axis perpendicular to the first transmission axis; wherein
an incident light from a backlight unit would sequentially pass the first polarizing film, the first substrate, the liquid crystal layer, the second substrate and the second polarizing film; the first substrate and the second substrate have a plurality of double-domain pixel electrodes.

4. The liquid crystal display device as claimed in claim 3, wherein each of the double-domain pixel electrodes comprises a first comb-shaped electrode and a second comb-shaped electrode, the first comb-shaped electrode being interdigitated with the second comb-shaped electrode.

5. The liquid crystal display device as claimed in claim 4, wherein the first comb-shaped electrode comprises a plurality of spacedly arranged first bending portions and a first connecting portion, the first connecting portion being connected with the plurality of spacedly arranged first bending portions to form a comb-shaped structure.

6. The liquid crystal display device as claimed in claim 5, wherein the second comb-shaped electrode comprises a plurality of spacedly arranged second bending portions and a second connecting portion, the second connecting portion being connected with the plurality of spacedly arranged second bending portions to form a comb-shaped structure; the plurality of first bending portions and the plurality of second bending portions are spacedly arranged from each other.

7. The liquid crystal display device as claimed in claim 6, wherein each of the plurality of first bending portions and the second connecting portion have a first gap formed therebetween, each of the plurality of second bending portions and the first connecting portion have a second gap formed therebetween.

8. The liquid crystal display device as claimed in claim 5, wherein each of the first bending portions is a “>” shape.

9. The liquid crystal display device as claimed in claim 5, wherein each of the first bending portions is a “<” shape.

10. The liquid crystal display device as claimed in claim 4, wherein the first comb-shaped electrode and the second comb-shaped electrode are configured for forming a horizontal electric field.

11. The liquid crystal display device as claimed in claim 3, wherein the liquid crystal layer contains dichroic dyes and liquid crystal molecules, the dichroic dyes being parallel to the liquid crystal molecules.

12. The liquid crystal display device as claimed in claim 3, wherein major axes or minor axes of the dichroic dyes are configured for absorbing a part of linear polarized light from the first polarizing film.

13. The liquid crystal display device as claimed in claim 3, wherein the liquid crystal display device uses a fringe field switching mode or an in-plane switching mode.
